(19) United States
(12) Patent Application Publication
(10) Pub. No.: US 2001/0024166 A1
(43) Pub. Date: Sep. 27, 2001

(54) Visual warning system for emergency vehicles

(76) Inventor: Bill Donald Baker, Owasso, OK (US)

Correspondence Address: BILL D. BAKER, 8903 N. 121ST E. AVE., OWASSO, OK, 74055, US

(21) Appl. No.: 09/681,357

(22) Filed: Mar. 25, 2001

(51) Int. Cl. G08G 1/00

(52) U.S. Cl. 340/902; 340/468; 340/470; 340/471

(57) ABSTRACT

This system is a compliment to the sirens and lights now used on emergency vehicles it will help with warning of vehicles in the area and could reduce time of arrival for emergency vehicles. The system will need to be installed in all emergency vehicles first and then into the passenger vehicles to get immediate benefits from this system

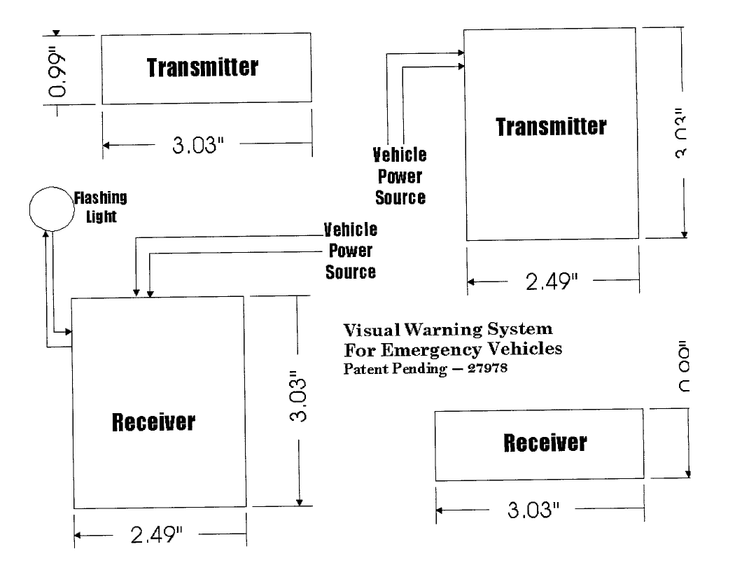

### DETAILED DESCRIPTION

The system is comprised of a transmitter and a receiver 1×3×2.5 inch's the transmitter is placed in the emergency vehicle's and is activated when sirens or lights are turned on. The receiver is placed in passenger vehicles and is on whenever the car is started. The Transmitter will emit a signal that will turn on the receiver activating a flashing warning light whenever the emergency vehicle is within a ½ mile radius. The system will be powered by the vehicles electrical system. and will be placed out of sight except for the warning light.

1. A method of activating a flashing light when emergency vehicles are within a ½ mile radius warning the passengers of emergency vehicles allowing more time to merge or exit the area:

2. A method of reducing collisions in intersections because cars are being built so sound proof that sirens cannot be heard.

3. A method visual warning to benefit those with hearing disabilities to know that emergency vehicles are in the area.
